(19) United States
(12) Patent Application Publication
(10) Pub. No.: US 2004/0007535 A1
(43) Pub. Date: Jan. 15, 2004

(54) Water softening method and system

(75) Inventor: Sittichai Siriphraiwan, Poway, CA (US)

Correspondence Address: FOLEY & LARDNER, 402 WEST BROADWAY, 23RD FLOOR, SAN DIEGO, CA, 92101

(73) Assignee: Tru Industries

(21) Appl. No.: 10/193,843

(22) Filed: Jul. 12, 2002

(51) Int. Cl. C02F 1/48

(52) U.S. Cl. 210/695; 210/222; 210/512.1; 210/788

(57) ABSTRACT

A method and system for softening water or other fluids is disclosed. A flow of fluid is treated such as by exposing it to a magnetic field to cause a chemical reaction in the flow, whereby a product in the fluid breaks down into a gaseous byproduct and a particulate byproduct. The flow is then agitated by, for example, repeatedly cycling the flow through an undulating path of travel to cause the gaseous byproduct to become disassociated from the fluid. The undissolved gaseous byproduct may then be vented. The particulate byproduct may then be separated from the fluid by, for example, a cyclone separator. The separated particulate byproduct may then be flushed from said flow.

### BACKGROUND OF THE INVENTION

1. Field of the Invention

The invention relates to fluid treatment systems. In particular, the present invention relates to a method and system for softening water or other fluids.

2. Related Art

The information contained in this section relates to the background of the art of the present invention without any admission as to whether or not it legally constitutes prior art.

In many communities around the United States and around the world, the water available is generally hard water. Hard water contains products such as calcium and magnesium products, including calcium bicarbonate. These products may be undesirable for several reasons. For example, these products may cause the hard water to have an undesirable taste. Further, use of hard water in such appliances as clothes or dish washing machines may cause reduced performance of the appliances. For example, washing machines using hard water may fail to sufficiently and optimally clean the clothes or dishes.

Several systems are known for softening the hard water. These systems generally require the addition of salt to ionize the water. While these systems may provide certain desirable results, such as soft water for washing clothes and dishes, they generally do not result in a purified fluid. Rather than providing pure water, these systems result in the addition of further products to the water. Additionally, there is an unwanted expense and effort to buy and to add the salt to the water softener.

Magnetic systems have been used to break down some of the products in the hard water. For example, reference may be made to U.S. Pat. Nos. 2,596,743 and 5,074,998. The U.S. Pat. Nos. 2,596,743 and 5,074,998 are hereby incorporated herein by reference. Such systems generally apply a magnetic field to the hard water flowing through a pipe. The magnetic field may cause a chemical reaction which breaks down the products into less undesirable products. For example, calcium bicarbonate may be broken down into a calcium carbonate sediment and a carbon dioxide gas. The calcium carbonate sediment forms a soft scale and sometimes a precipitate.

These systems, however, have not been entirely satisfactory for some applications. First, despite the breakdown, an undesirable sediment remains in the form of, for example, calcium carbonate. Second, the presence of carbon dioxide gas in the water may be undesirable in some applications. Third, the chemical reaction caused by the magnetic field may reverse itself in a short period since the products of the reaction remain in the fluid. For example, the calcium carbonate sediment may react with the carbon dioxide gas to again form the original product, calcium bicarbonate.

### BRIEF DESCRIPTION OF THE DRAWINGS

In the following, the invention will be explained in further detail with reference to the drawings, in which:

FIG. 1 is a diagrammatic view of an embodiment of a water softening system according to one embodiment of the present invention; and

FIG. 2 is a pictorial diagrammatic view of the water softening system of FIG. 1.

### DESCRIPTION OF CERTAIN EMBODIMENTS OF THE INVENTION

The present invention provides a system and a method for softening water or other fluids by breaking down an undesirable product in the fluid into a gaseous byproduct and a particulate byproduct. A flow of fluid may be treated by, for example, exposing it to a magnetic field which causes the breaking down of the undesirable product. The flow may then be agitated to thoroughly separate the gaseous byproduct from the flow. The gaseous product may then be removed from the flow by, for example, venting. The particulate byproduct may then be separated and flushed from the flow, resulting in a treated form of fluid.

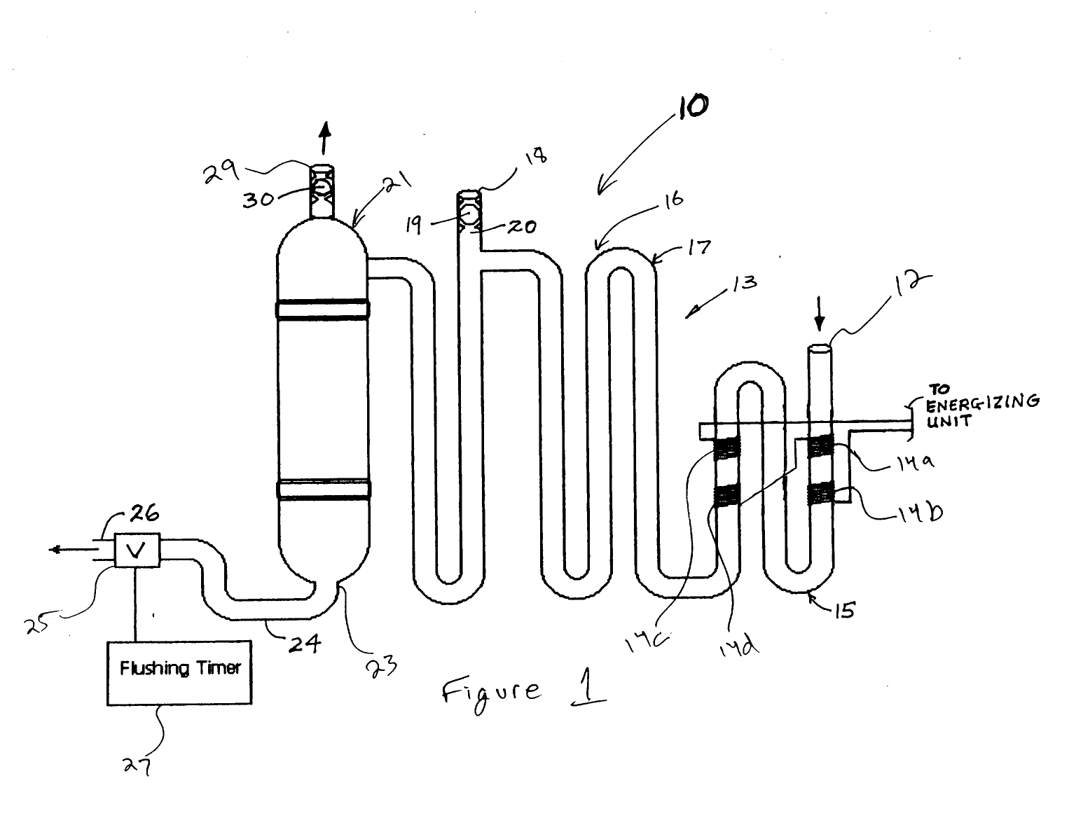

FIG. 1 illustrates one embodiment of a fluid softening system according to an example of the present invention. It is to be understood that while the preferred embodiment of the invention relates to a softening system for water, the inventive system may be employed with other fluids as well.

The softening system 10 includes an inlet 12 through which water or other fluids to be treated may be received under pressure from, for example, a water purifier, a well, a reservoir or a community water supply. The inlet 12 directs the flow of water through a pipe system generally indicated at 13. The pipe system 13 may be made of any of a variety of well known materials.

Downstream of the inlet 12 of the pipe system 13, a series of series-connected magnetic coils 14a-14d surround portions of an S-shaped pipe 15. The magnetic coils 14a-14d are spaced-apart and connected to an electronic coil energizing unit (not shown), which electrically energizes the coils to cause them to generate a magnetic field within the pipe 15. Such an energizing unit may be the one disclosed in U. S. Pat. No. 5,074,998 incorporated herein by reference.

When hard water flowing through the pipe 15 is exposed to the magnetic field, a chemical reaction is initiated within the pipe. The magnetic field causes a product in the water, such as calcium bicarbonate, to break down into a gaseous byproduct, such as carbon dioxide, and a particulate byproduct, such as calcium carbonate.

Other byproducts may result from the chemical reaction as well. For example, the breakdown of the calcium bicarbonate may initially produce carbonic acid, which in turn may break down into water and additional carbon dioxide.

Following the chemical breakdown of the undesired product, the gaseous and particulate byproducts are generally well-blended with the water within the pipe. The gaseous byproduct may generally remain dissolved in the fluid. Thus, it is desired to remove the unwanted byproduct such as calcium carbonate before it recombines and remains in solution in the water.

This magnetically treated water may then be guided through an agitation portion generally indicated at 16 of the pipe system 13. The flow of fluid through the agitation portion 16 causes the gaseous byproduct to become undissolved. In the embodiment illustrated in FIG. 1, the agitation portion 16 includes a larger S-shaped pipe section 17 which may guide the water flow through an undulating path of travel. A suitable number of back-and-forth segments in the agitation portion 16 may be selected to achieve a desired effect of releasing the gaseous byproduct in the water.

Downstream of the agitation portion 16, a gas vent 18 may be provided to permit the gaseous byproduct to escape from the water flow. Preferably, the vent 18 is fitted with a de-gas valve 19, thereby preventing the entry of additional unwanted gaseous components to the pipe system 13 and yet permits the release of the unwanted gaseous byproduct. The vent 18 is preferably located at the top of an upright stub pipe 20 to allow the natural flow of the gaseous byproduct to assist in its removal from the water flow. The piping system 13 is generally upright as shown in the drawing, according to a preferred form of the invention.

As mentioned previously, by removing the gaseous byproduct, the unwanted byproduct such as calcium carbonate is prevented from re-combining and remaining in solution in the water. Thus, the calcium carbonate may then be flushed from the system 10 to leave softened water.

A cyclone separator 21 is provided downstream of the stub pipe 20 in the pipe system 13. The cyclone separator 21 is conventional and causes the water flow to be spun in a vortex. This spinning of the water flow causes the particulate byproduct to be separated from the water and allows the particulate byproduct to be flushed out of a bottom outlet 23 of the cyclone separator 21 as a sediment. When sufficient sediment has accumulated in a pipe 24 connected in fluid communication with the bottom outlet 23, the sediment may be flushed from the system through a valve 25 and a drainage outlet pipe 26 to a suitable sludge removal line (not shown). The valve 25 may be a manual valve opened by an operator either upon measurement of sufficient sediment or at regular timed intervals. In the illustrated embodiment, the valve 25 is a solenoid valve that may be automatically actuated by a flushing timer 27 at a regular timed interval.

With the gaseous byproduct vented and the particulate byproduct settled as a sediment, a treated form of soft water may be directed out of the cyclone separator 21 and the water softening system 10 through an outlet 29. The outlet nozzle 29 may be either a faucet for immediate use of the water or a pipe leading to a storage tank or reservoir (not shown) for storing the treated water. The outlet 29 is fitted with a gas vent valve 30, which is similar to the valve 19, to permit gas release from the water following the vortex action.

Thus, with the byproducts of the chemical reaction removed from the water flow, little or no undesirable sediment remains in the water. Finally, since the byproducts of the chemical reaction are removed from the flow, there is little or no chance of the reaction reversing itself.

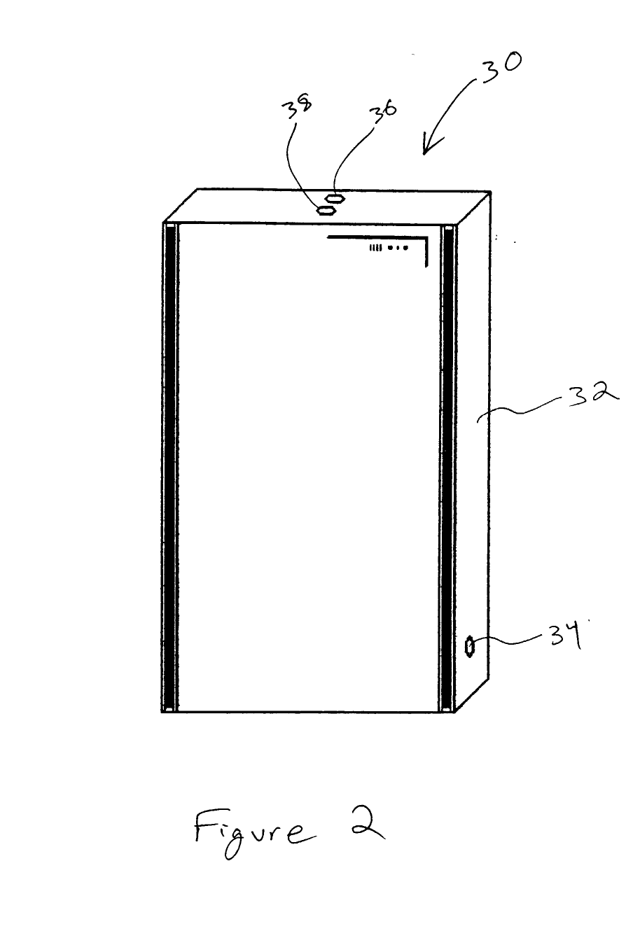

FIG. 2 illustrates another embodiment of a water softening system according to another example of the present invention. The system 30 includes a housing 32 which may house all of the components of the water softener. For example, the components (not shown) of the system 30 are similar to the components of the system 10 of FIG. 1, and are sized and configured to fit inside the housing 32. The housing may be provided with a sediment flushing outlet 34 similar to the pipe 26 through which a settled sediment containing a particulate byproduct may be removed from the water flow and from the system 30. Further, on a top portion of the housing 32, a gas vent 36 similar to the vent 18 and a treated water outlet 38 similar to the outlet 29 may be provided. Thus, a treated form of soft water may be obtained through the outlet 38 with the gaseous byproduct and the particulate byproduct removed utilizing a conveniently packaged unit.

While particular embodiments of the present invention have been disclosed, it is to be understood that various different modifications and combinations are possible and are contemplated within the true spirit and scope of the appended claims. There is no intention, therefore, of limitations to the exact abstract and disclosure herein presented.

What is claimed is:

1. A method of treating flowing fluid, comprising:
treating a flow of fluid to generate a gaseous byproduct and a particulate byproduct;
agitating said fluid to cause said gaseous byproduct to become undissolved from said fluid;
venting said undissolved gaseous byproduct from said flow; and
causing said particulate byproduct to separate from said fluid.

2. The method according to claim 1, wherein said treating includes generating magnetic field and directing it in the flowing fluid.

3. The method according to claim 1, wherein said magnetic field causes a chemical reaction in the flow, said chemical reaction causing a product in said fluid to break down into said gaseous byproduct and said particulate byproduct.

4. The method according to claim 1, wherein said agitating includes repeatedly cycling said flow through an undulating path of travel.

5. The method according to claim 1, wherein said causing said particulate byproduct to separate includes processing said fluid through a cyclone separator, thereby causing said particulate byproduct to settle separately from said fluid.

6. The method according to claim 1, further comprising:
flushing said separated particulate byproduct from said flow.

7. A system for treating flowing fluid, comprising:
means for treating a flow of fluid to generate a gaseous byproduct and a particulate byproduct;
means for agitating said fluid to cause said gaseous byproduct to become undissolved from said fluid;
means for venting said undissolved gaseous byproduct from said flow; and
means for separating said particulate byproduct from said fluid.

8. The system according to claim 7, wherein said means for treating includes means for generating a magnetic field directed in said flow.

9. The system according to claim 7, wherein said magnetic field is adapted to cause a chemical reaction in the flow, said chemical reaction causing a product in said fluid to break down into said gaseous byproduct and said particulate byproduct.

10. The system according to claim 7, wherein said means for agitating includes means for guiding the flow along an undulating path of travel.

11. The system according to claim 7, wherein said means for separating includes a cyclone separator adapted to cause said particulate byproduct to settle separately from said fluid.

12. The system according to claim 7, further comprising:
means for flushing said separated particulate byproduct from said flow.

13. A system for treating flowing fluid, comprising:
a magnetic generator adapted to break down an undesired product in a fluid flow into a gaseous byproduct and a particulate byproduct;
a fluid agitator adapted to cause said gaseous byproduct to become undissolved from said fluid; and
a separator adapted to separate said particulate byproduct from said fluid.

14. The system according to claim 13, wherein a pipe guides the fluid flow and said generator includes a set of coils operatively associated with the pipe carrying said flow.

15. The system according to claim 13, wherein said fluid agitator includes a pipe for guiding the fluid flow along an undulating path of travel adapted to carry said fluid flow.

16. The system according to claim 13, further comprising:
a vent adapted to remove said undissolved gaseous byproduct from said flow.

17. The system according to claim 16, further including a de-gasing valve fitted at said vent.
